(19) United States
(12) Patent Application Publication
(10) Pub. No.: US 2006/0104611 A1
(43) Pub. Date: May 18, 2006

(54) FLEXIBLE CONFLICT RESOLUTION IN SCHEDULED RECORDING OF BROADCAST CONTENT

(75) Inventors: John Taylor Gildred, Oakland, CA (US); Victor Vedovato, Santa Clara, CA (US)

Correspondence Address: DVA/PIONEER RESEARCH CENTER USA, INC.;INTELLECTUAL PROPERTY DEPARTMENT, 2355 MAIN STREET, SUITE 200, IRVINE, CA, 92614, US

(73) Assignee: PIONEER RESEARCH CENTER USA, INC., San Jose, CA (US)

(21) Appl. No.: 10/904,538

(22) Filed: Nov. 15, 2004

(51) Int. Cl. H04N 5/445; H04N 5/91; G06F 13/00; G06F 3/00

(52) U.S. Cl. 386/83; 725/58

(57) ABSTRACT

One embodiment of the invention is a technique to resolve recording conflict in program recording. A conflict is detected in recording first and second programs. The conflict is caused by an overlapping segment occupying a time period common to desired recording times of the first and second programs. A user is allowed to select recording the first program without the overlapping segment.

### BACKGROUND OF THE INVENTION

1. Field of the Invention

Embodiments of the invention relate to the field of broadcast recording, and more specifically, to conflict resolution in scheduled recording.

2. Description of Related Art

Television scheduled recording allows a user to select a show or program in a program schedule to be recorded at a future time. The user typically selects the recording start and stop times for a particular broadcast show or program based on the information in the program guide. The user may select several future or current programs to be recorded. When multiple programs to be recorded are overlapped, a recording conflict arises. In addition, in some recording techniques, the user has an option to add additional time beyond the scheduled time using a padding option. When this padded time overlaps with another schedule recording time, a conflict also arises.

Existing conflict resolution techniques have a number of drawbacks. One technique simply lets the user to decide which program to be recorded when a conflict is detected. Another technique assigns a priority to each program. When there is a conflict, the program having a higher priority will be recorded while the lower priority programs are totally ignored. In these techniques, when there is a conflict, only one program will be recorded while the other program(s) are totally ignored.

### BRIEF DESCRIPTION OF THE DRAWINGS

The invention may best be understood by referring to the following description and accompanying drawings that are used to illustrate embodiments of the invention. In the drawings:

FIG. 1A is a block diagram illustrating a computer system in which one embodiment of the invention can be practiced.

FIG. 1B is a diagram illustrating a system in which one embodiment of the invention can be practiced.

FIG. 1C is a diagram illustrating a program recording module according to one embodiment of the invention.

FIG. 2 is a diagram illustrating a recording option selector according to one embodiment of the invention.

FIG. 3 is a diagram illustrating desired recording times according to one embodiment of the invention.

FIG. 4A is a diagram illustrating an overlapping time period including program segments according to one embodiment of the invention.

FIG. 4B is a diagram illustrating a program having more than one overlapping time periods according to one embodiment of the invention.

FIG. 5A is a diagram illustrating an overlapping time period including a post-roll segment according to one embodiment of the invention.

FIG. 5B is a diagram illustrating an overlapping time period including a post-roll segment according to one embodiment of the invention.

FIG. 5C is a diagram illustrating an overlapping time period including pre-roll and post-roll segments having post-roll segment not recorded according to one embodiment of the invention.

FIG. 5D is a diagram illustrating an overlapping time period including pre-roll and post-roll segments having pre-roll segment not recorded according to one embodiment of the invention.

FIG. 5E is a diagram illustrating an overlapping time period including pre-roll and post-roll segments and ending and beginning parts of programs according to one embodiment of the invention.

FIG. 5F is a diagram illustrating another overlapping time period including pre-roll and post-roll segments and ending and beginning parts of programs according to one embodiment of the invention.

### DESCRIPTION OF THE INVENTION

One embodiment of the invention is a technique to resolve recording conflicts in a program recording. A conflict is detected when first and second programs are scheduled to be recorded. The conflict is caused by an overlapping segment occupying a time period common to the desired recording times of the first and second programs. A user is allowed to select recording the first program without the overlapping segment.

In the following description, numerous specific details are set forth. However, it is understood that embodiments of the invention may be practiced without these specific details. In other instances, well-known circuits, structures, and techniques have not been shown in order not to obscure the understanding of this description.

Elements of one embodiment of the invention may be implemented by hardware, software, firmware, microcode, or any combination thereof. When implemented in software, firmware, or microcode, the elements of the embodiment of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the machine accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operation described in the following. The term “data” here refers to any type of information that is encoded for machine-readable purposes. Therefore, it may include program, code, data, file, etc.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

It is noted that an embodiment of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

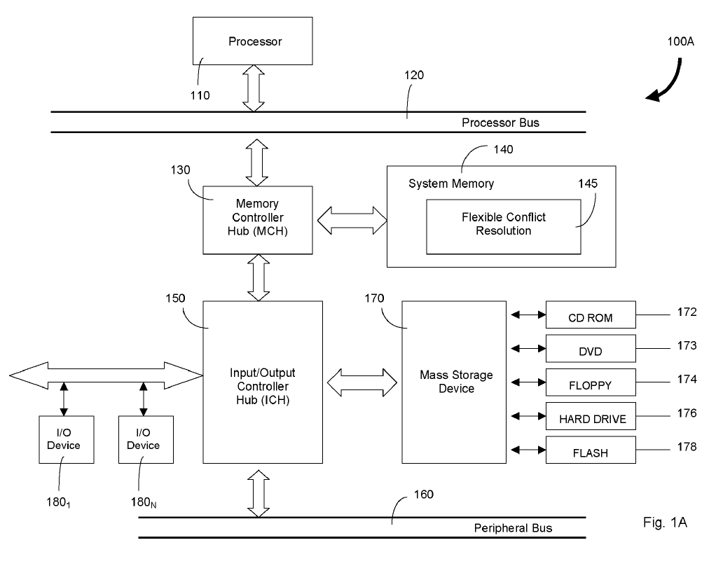

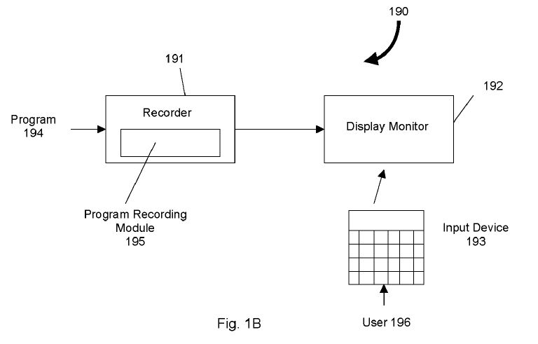

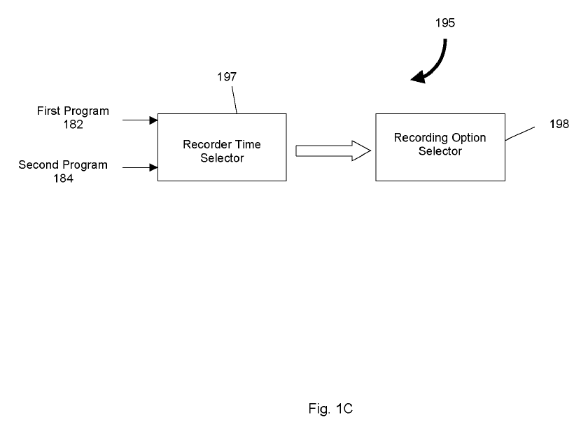

FIG. 1A is a diagram illustrating a processor system 100 in which one embodiment of the invention can be practiced. The processor system 100 includes a processor 110, a processor bus 120, a memory control hub (MCH) 130, a system memory 140, an input/output control hub (ICH) 150, a peripheral bus 160, a mass storage device 170, and input/output devices 180₁ to 180_{N}. Note that the processor system 100 may include more or less elements than these elements.

The processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The processor bus 120 provides interface signals to allow the processor 110 to communicate with other processors or devices, e.g., the MCH 130. The processor bus 120 may support a uni-processor or multiprocessor configuration. The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system 140 may also include peripheral buses such as Peripheral Component Interconnect (PCI), accelerated graphics port (AGP), Industry Standard Architecture (ISA) bus, and Universal Serial Bus (USB), etc.

The system memory 140 stores system code (i.e., code to calculate a shared key) and data. The system memory 140 is typically implemented with dynamic random access memory (DRAM) or static random access memory (SRAM). The system memory 140 may include program code or code segments implementing one embodiment of the invention. The system memory includes a user interface management (i.e. Flexible Conflict Resolution) 145. Any one of the elements of the user interface management 145 may be implemented by hardware, software, firmware, microcode, or any combination thereof. The system memory 140 may also include other programs or data, which are not shown, such as an operating system. The user interface management 145 contains program code that, when executed by the processor 110, causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disk (DVD) 173, floppy drive 174, hard drive 176, flash memory 178, and any other magnetic or optic storage devices. The mass storage device 170 provides a mechanism to read machine-accessible media. The machine-accessible media may contain computer readable program code to perform tasks as described in the following.

The I/O devices 180₁ to 180_{N} may include any I/O devices to perform I/O functions. Examples of I/O devices 180₁ to 180_{N} include controllers for input devices (e.g., keyboard, mouse, trackball, pointing device), media cards (e.g., audio, video, graphics), network cards, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EROM). Examples of firmware may include microcode, writable control store, and micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read-only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, causes the machine to perform the operations described in the following. The machine accessible medium may also include program code embedded therein. The program code may include machine-readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, an argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

FIG. 1B is a diagram illustrating a system 190 in which one embodiment of the invention can be practiced. The system 190 includes a recorder 191, a display monitor 192, and an input device 193.

The recorder 191 is a device that records a program 194. It may be an analog recorder, a digital recorder, a video cassette recorder (VCR), a digital versatile/video recorder (DVD). It may be integrated into the display monitor 192 or a computer system. It includes a program recording module 195 to resolve recording conflicts. The program 194 may be a broadcast television program, a video/audio program, a cable network program, a digital content delivered over a network (e.g., Internet). The recorder 191 may include a processor to execute program code to carry out the operations described in the following. The program code may be embodied in a machine readable medium such as memory, mass storage device, etc. as described above.

The display monitor 192 is any display device that displays the received program. It may be a television set, an analog or digital display, a flat panel display, a liquid crystal display, a cathode ray tube (CRT), etc. It may be integrated into a computer system.

The input device 193 allows a user 196 to interact with the recorder 191. It may have a keyboard, an infrared transmitter/receiver, a wireless transmitter/receiver, etc. It may be connected to the recorder 191 or the display monitor 192 in a wired or wireless connectivity. The user 196 uses the input device 193 to program recording of the program 194. The recorder 191 provides graphical user interface (GUI) to allow the user to select programs, channels, program schedules, program contents, etc.

FIG. 1C is a diagram illustrating the program recording module 195 according to one embodiment of the invention. The program recording module 195 may be a software function or module that is part of a programming system. It includes a recording time selector 197 and a recording option selector 198.

The recording time selector 197 allows the user to select desired recording times of first and second programs 182 and 184. Note that although only two programs are shown, any number of programs may be available for recording. The user typically scans a program schedule which shows the broadcast times of programs, episodes, or shows and selects the programs 182 and 184 to be recorded. The programs 182 and 184 are typically programs that are broadcast in the future, but they may also be currently broadcast programs. The recording times are typically the start and ending times of the selected program. They may also include padding times or times that are outside the scheduled time. These padding times may include a pre-roll time which is a time period or segment before the start of a program, and a post-roll time which is a time period or segment after the end of a program. The pre-roll and post-roll segments may be a time period of any length (e.g., one minute, two minutes, five minutes, fifteen minutes, thirty minutes).

The recording times for the first and second programs 182 and 184 may overlap and therefore result in a recording conflict. The conflict may be resolved by allowing the user options to select when a program is recorded.

The recording option selector 198 is a function or module to provide the user the options to record the programs. When a conflict arises, the program recording module 195 generates a selection menu or items to allow the user to decide which program or which portion of a program to be recorded.

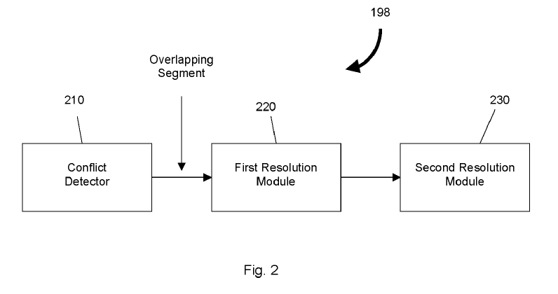

FIG. 2 is a diagram illustrating the recording option selector 198 according to one embodiment of the invention. The recording option selector 198 includes a conflict detector 210, a first conflict resolution module 220 and a second conflict resolution module 230.

The conflict detector 210 detects a conflict in recording the first and second programs 182 and 184. As discussed above, the conflict is caused by an overlapping segment occupying a time period common to the desired recording times of the first and second programs 182 and 184. This conflict may be detected by comparing the starting and ending recording times of the first and second programs 182 and 184. When the starting recording time or ending recording time of one program is within the starting recording time and ending recording time of another program, a conflict is detected. The overlapping segment may be a part of or the entire overlapping time period between the two programs.

The first conflict resolution module 220 is invoked when a conflict is detected by the conflict detector 210. As will be described later, the first conflict resolution module 220 allows the user to select recording the first program 182 without the overlapping segment. The second conflict resolution module 230 allows the user to select recording the second program 184 with or without the overlapping segment.

The decision to provide the options to the user to select recording times depends on how the overlapping occurs. This is characterized by the nature of the overlapping segment.

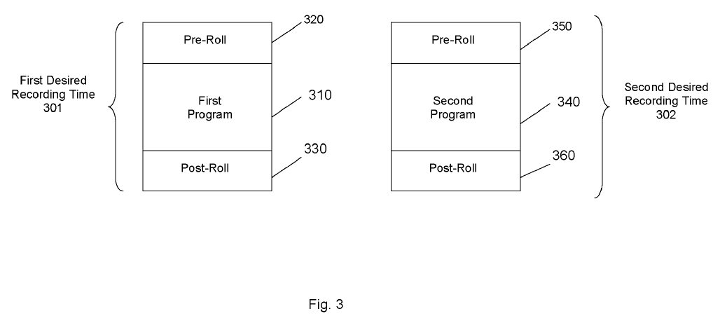

FIG. 3 is a diagram illustrating desired recording times according to one embodiment of the invention. There are two desired recording times: a desired recording time for the first program 301 and a desired recording time for the second program 302.

The desired recording time 301 includes a pre-roll segment 320, a first program 310, and a post-roll segment 330. Similarly, the desired recording time 302 includes a pre-roll segment 350, a second program 340, and a post-toll segment 360. Note that not all of these segments are included in the desired recording times 301 and 302. For example, the desired recording time 301 may include only the first program 310 while the desired recording time 302 may include the pre-roll segment 350 and the second program 340. Any combination of these segments is contemplated.

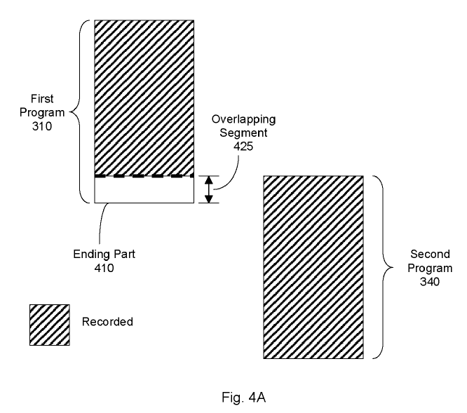

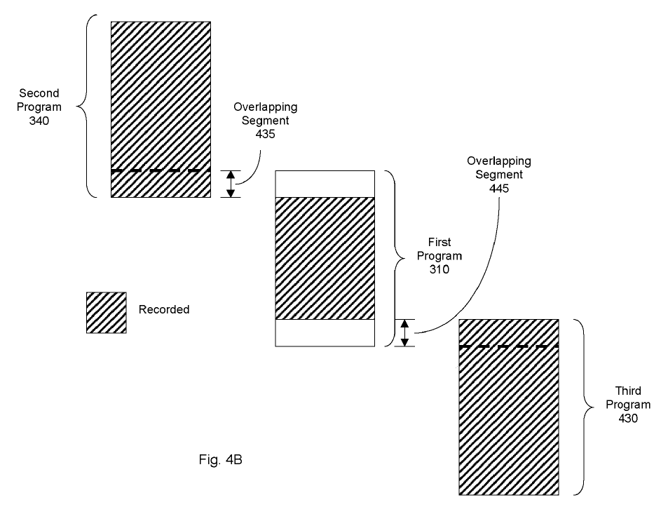

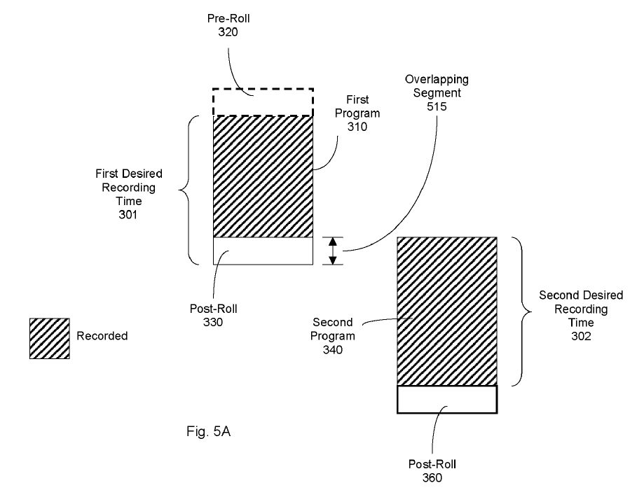

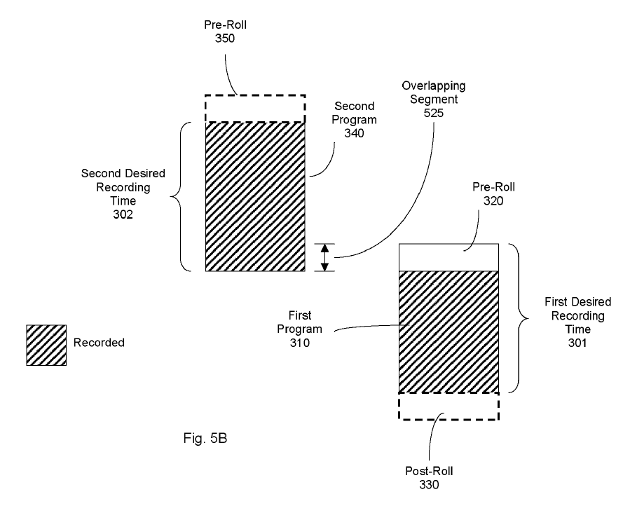

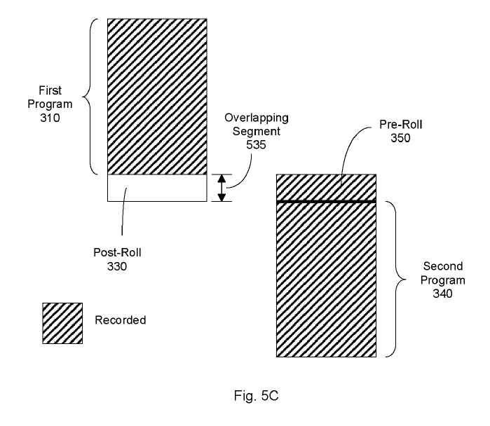

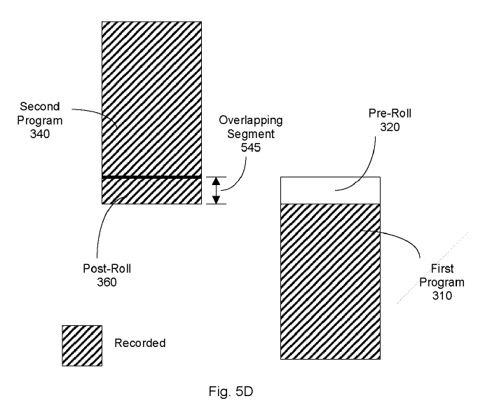

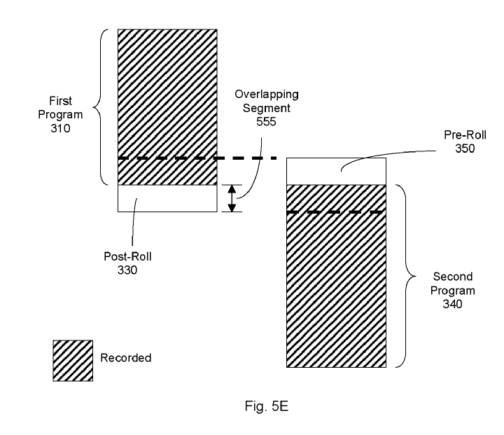

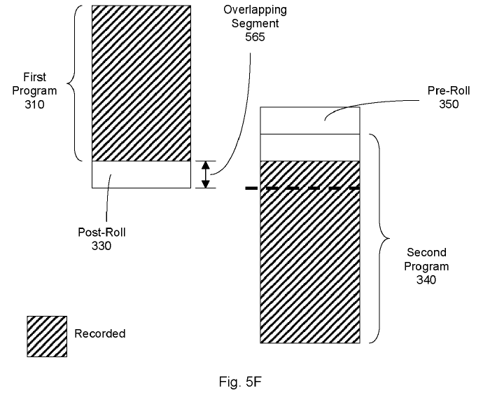

The overlapping segment between the two desired recording times is a result of several conflict scenarios as depicted in FIGS. 4A-4B and 5A through 5F. For each scenario, a conflict strategy is employed.

FIG. 4A is a diagram illustrating an overlapping time period including program segments according to one embodiment of the invention.

In this scenario, the desired recording times for the first and second programs 310 and 340 are the same as their scheduled times without pre-roll or post-roll segments. The first program 310 has an ending part 410 that is overlapped with a beginning part of the second program 340 in an overlapping segment 425. The overlapping segment 425 is equal to the overlapping time period. The first conflict resolution option, performed by the first conflict resolution module 220 in FIG. 2, is to allow the user to select recording the first program without the overlapping segment 425. The second conflict resolution option, performed by the first conflict resolution module 220 in FIG. 2, is to allow the user to select recording the second program 340 with the overlapping segment 425.

FIG. 4B is a diagram illustrating a program having more than one overlapping time periods according to one embodiment of the invention.

In this scenario, the first program 310 has an overlapping segment 435 with the second program 340 and an overlapping segment 445 with a third program 430. The first conflict resolution option is to allow the user to select recording the first program 310 without the overlapping segments 435 and 445.

FIG. 5A is a diagram illustrating an overlapping time period including a post-roll segment according to one embodiment of the invention.

In this scenario, the first desired recording time 301 includes the first program 310 and the post-roll segment 330 with or without the pre-roll segment 320. The second desired recording time 302 includes the second program 340 with or without the post-roll segment. The two desired recording times are overlapped resulting in an overlapping time period which includes an overlapping segment 515.

The overlapping segment 515 may include the entire post-roll segment 330 or only a portion of it. For example, suppose the end time of the first program 310 is 8:00 AM, the post-roll segment 330 is 10 minutes, and the start time of the second program 340 is 8:00 AM. Then the overlapping segment 515 is the same as the post-roll segment 330. If the start time of the second program is 8:05 AM, then the overlapping segment may be defined as the same as the post-roll segment 330 or only the time period from 8:05 AM to 8:10 AM. In both examples, the user is provided with the first resolution option to record the first program 310 without the overlapping segment 515 and the second resolution option to record the second program 340 with the overlapping segment 515. In the first example, the overlapping segment 515 is the same as the post-roll segment 330. In the second example, the first program 310 may be recorded up to 8:00 AM or up to 8:05 AM while the second program 340 is recorded from 8:05 AM.

FIG. 5B is a diagram illustrating an overlapping time period including a post-roll segment according to one embodiment of the invention.

In this scenario, the first desired recording time 301 includes the first program 310 and the pre-roll segment 320 with or without the post-roll segment 330. The second desired recording time 302 includes the second program 340 with or without the pre-roll segment 350. The two desired recording times are overlapped resulting in an overlapping time period, which includes an overlapping segment 525.

As in the scenario shown in FIG. 5A, the overlapping segment 525 may include the entire pre-roll segment 330 or only a portion of it. The same conflict resolution options are used. The first conflict resolution option is to allow the user to record the first program without the pre-roll segment 320 or only a portion of it. The second conflict resolution is to allow the user to record the second program 340 with the overlapping segment 525 up to its scheduled end time.

FIG. 5C is a diagram illustrating an overlapping time period including pre-roll and post-roll segments having post-roll segment not recorded according to one embodiment of the invention.

In this scenario, the first desired recording time 301 includes the first program 310 and the post roll segment 330. The second desired recording time 302 includes the second program 340 and the pre-roll segment 350. The two desired recording times are overlapped resulting in an overlapping time period, which includes an overlapping segment 535.

The overlapping segment 535 may include the entire or a portion of the post-roll segment 330 and the pre-roll segment 350. The first resolution option is to allow the user to select recoding the first program 310 up to its scheduled end time or up to its end time plus a portion of its post-roll segment 330. The second resolution option is to allow the user to select recording the second program from its scheduled start time or from a portion of its pre-roll segment 350.

FIG. 5D is a diagram illustrating an overlapping time period including pre-roll and post-roll segments having pre-roll segment not recorded according to one embodiment of the invention.

In this scenario, the first desired recording time 301 includes the first program 310 and the pre-roll segment 320 with or without the post-roll segment 330. The second desired recoding time 302 includes the second program 340 and the post-roll segment 360 with or without the pre-roll segment 350. The two desired recording times are overlapped resulting in an overlapping time period, which includes an overlapping segment 545.

The overlapping segment 545 may include the entire or a portion of the post-roll segment 360 and the pre-roll segment 320. The first resolution option is to allow the user to select recoding the first program 310 from its scheduled start time or from a portion of its pre-roll segment 320. The second resolution option is to allow the user to select recording the second program up to its scheduled end time or up to its end time plus a portion of its post-roll segment 360.

FIG. 5E is a diagram illustrating an overlapping time period including pre-roll and post-roll segments and ending and beginning parts of programs according to one embodiment of the invention.

In this scenario, the first desired recording time 301 includes the first program 310 and the post roll segment 330. The second desired recording time 302 includes the second program 340 and the pre-roll segment 350. The two desired recording times are overlapped resulting in an overlapping time period, which includes an overlapping segment 555.

The overlapping segment 555 may include the entire or a portion of the post-roll segment 330 and the pre-roll segment 350. The first resolution option is to allow the user to select recoding the first program 310 up to its scheduled end time, or up to its end time plus a portion of its post-roll segment 330, or up to a portion before its scheduled end time. The second resolution option is to allow the user to select recording the second program from its scheduled start time or from a portion of its pre-roll segment 350.

FIG. 5F is a diagram illustrating another overlapping time period including pre-roll and post-roll segments and ending and beginning parts of programs according to one embodiment of the invention.

In this scenario, the first desired recording time 301 includes the first program 310 and the post roll segment 330. The second desired recording time 302 includes the second program 340 and the pre-roll segment 350. The two desired recording times are overlapped resulting in an overlapping time period, which includes an overlapping segment 565.

The overlapping segment 565 may include the entire or a portion of the post-roll segment 330 and the pre-roll segment 350 with or without an ending part of the first program 310 and/or with or without a beginning part of the second program 340. The first resolution option is to allow the user to select recoding the first program 310 up to its scheduled end time, or up to a portion before its scheduled end time. The second resolution option is to allow the user to select recording the second program from a portion of away from its start time.

Other scenarios may include more than two programs with all possible overlapping patterns. The resolution options are such that not one program is ignored or not recorded entirely. The overlapping segment may be defined in a flexible manner. The first resolution option is to allow the user to select recording the first program without this defined overlapping segment. The second resolution option is to allow the user to select recording the second program with or without this defined overlapping segment.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
detecting a conflict in recording first and second programs, the conflict being caused by an overlapping segment occupying a time period common to desired recording times of the first and second programs; and
allowing a user to select recording the first program without the overlapping segment.

2. The method of claim 1 further comprising:
allowing the user to select recording the second program with the overlapping segment.

3. The method of claim 1 wherein the overlapping segment includes parts of the first and second programs.

4. The method of claim 1 wherein the overlapping segment includes a pre-roll segment or a post-roll segment of the first or second programs.

5. The method of claim 1 wherein the overlapping segment includes a post-roll segment and an ending part of the first program.

6. The method of claim 5 further comprising:
allowing the user to select recording the first program with the ending part.

7. The method of claim 1 wherein the overlapping segment includes a pre-roll segment and a beginning part of the second program.

8. The method of claim 7 further comprising:
allowing the user to select recording the second program without the pre-roll segment.

9. The method of claim 1 further comprising:
allowing the user to select recording the second program without the overlapping segment.

10. The method of claim 1 wherein at least one of the first and second programs is broadcast.

11. An article of manufacture comprising:
a machine-accessible medium including data that, when accessed by a machine, causes the machine to perform operations comprising:
detecting a conflict in recording first and second programs, the conflict being caused by an overlapping segment occupying a time period common to desired recording times of the first and second programs; and
allowing a user to select recording the first program without the overlapping segment.

12. The article of manufacture of claim 11 wherein the data further comprises data that, when accessed by the machine, causes the machine to perform operations comprising:
allowing the user to select recording the second program with the overlapping segment.

13. The article of manufacture of claim 11 wherein the overlapping segment includes parts of the first and second programs.

14. The article of manufacture of claim 11 wherein the overlapping segment includes a pre-roll segment or a post-roll segment of the first or second programs.

15. The article of manufacture of claim 11 wherein the overlapping segment includes a post-roll segment and an ending part of the first program.

16. The article of manufacture of claim 15 wherein the data further comprises data that, when accessed by the machine, causes the machine to perform operations comprising:
allowing the user to select recording the first program with the ending part.

17. The article of manufacture of claim 11 wherein the overlapping segment includes a pre-roll segment and a beginning part of the second program.

18. The article of manufacture of claim 17 wherein the data further comprises data that, when accessed by the machine, causes the machine to perform operations comprising:
allowing the user to select recording the second program without the pre-roll segment.

19. The article of manufacture of claim 11 wherein the data further comprises data that, when accessed by the machine, causes the machine to perform operations comprising:
allowing the user to select recording the second program without the overlapping segment.

20. The article of manufacture of claim 111 wherein at least one of the first and second programs is broadcast.

21. A program recording module comprising:
a first module to allow a user to select desired recording times of first and second programs; and
a second module coupled to the first module, the second module comprising:
a conflict detection module to detect a conflict in recording first and second programs, the conflict being caused by an overlapping segment occupying a time period common to desired recording times of the first and second programs, and
a first conflict resolution module to allow a user to select recording the first program without the overlapping segment.

22. The program recording module of claim 21 wherein the second module further comprises:
a second conflict resolution module to allow the user to select recording the second program with the overlapping segment.

23. The program recording module of claim 21 wherein the overlapping segment includes parts of the first and second programs.

24. The program recording module of claim 21 wherein the overlapping segment includes a pre-roll segment or a post-roll segment of the first or second programs.

25. The program recording module of claim 21 wherein the overlapping segment includes a post-roll segment and an ending part of the first program.

26. The program recording module of claim 25 wherein the second module further comprises:
a second conflict resolution module to allow the user to select recording the first program with the ending part.

27. The program recording module of claim 21 wherein the overlapping segment includes a pre-roll segment and a beginning part of the second program.

28. The program recording module of claim 27 wherein the second module further comprises:
a second conflict resolution module to allow the user to select recording the second program without the pre-roll segment.

29. The program recording module of claim 21 wherein the second module further comprises:
a second conflict resolution module to allow the user to select recording the second program without the overlapping segment.

30. The program recording module of claim 21 wherein at least one of the first and second programs is broadcast.
